(19) United States
(12) Patent Application Publication
(10) Pub. No.: US 2010/0029824 A1
(43) Pub. Date: Feb. 4, 2010

(54) STYRENE-CONTAINING POLYMERS CONTAINING A ZEOLITE OF THE MFI TYPE

(75) Inventors: Melanie Steigelmann, Edingen-Neckarhausen (DE); Philippe Desbois, Edingen-Neckarhausen (DE); Norbert Niessner, Singapore (SG); Davy Roger Suwier, Tampico (MX); Ulrich Müller, Neustadt (DE)

Correspondence Address: CONNOLLY BOVE LODGE & HUTZ, LLP, P O BOX 2207, WILMINGTON, DE, 19899, US

(73) Assignee: BASF SE Patents, Trademark and Licenses, Ludwigshafen (DE)

(21) Appl. No.: 12/516,479

(22) PCT Filed: Nov. 27, 2007
(86) PCT No.: PCT/EP07/62851

§ 371 Date: May 27, 2009

(30) Foreign Application Priority Data
Dec. 1, 2006 (EP) 06125236.7

(51) Int. Cl. C08K 3/34

(52) U.S. Cl. 524/443; 524/450

(57) ABSTRACT

Molding compositions comprising at least one styrene polymer and comprising at least one zeolitic material of MFI structure type, a process for removal of styrene monomer from styrene polymer, and the use of at least one zeoltic material of MFI structure type for removal of styrene monomer from a molding composition comprising styrene polymer.

The invention relates to molding compositions comprising at least one styrene polymer and comprising at least one zeolitic material of MFI structure type, a process for removal of styrene monomer from styrene polymer, and the use of at least one zeolitic material of MFI structure type for removal of styrene monomer from a molding composition comprising styrene polymer.

The use of zeolitic material in conjunction with polymers is known.

For example, EP 1 170 327 A1 describes a plastic which comprises at least one zeolite for adsorption of volatile organic compounds, in particular ethylene, from gases or from gas mixtures. The parent material used can be very many polymers, and polystyrene is mentioned inter alia. However, polystyrene is not used in any of the examples. The zeolites are intended to have hydrophobic character, and a very wide variety of zeolites is mentioned, those mentioned including zeolites of MFI structure type.

DE 100 62 558 describes a process for removal of undesired odors via adsorption of the odor-generating substances on mesoporous silicas or on metal silicates, and also describes plastics which comprise porous silicas or metal silicates. The parent materials that can be used are again very many polymers, and polystyrene is likewise mentioned here.

EP 0 839 071 B1 describes a membrane for pervaporation of volatile organic compounds from water, this comprising a polymeric membrane filled with at least one hydrophobic adsorbent. The polymeric membrane can be composed of a wide variety of polymers, and styrene-butadiene rubber is mentioned here inter alia. The hydrophobic adsorbent can likewise be selected from a wide variety of materials, and zeolites are also mentioned here.

U.S. Pat. No. 2,977,346 describes a process for removal of unreacted aromatic hydrocarbon monomers from reaction product of polymerization of a hydrocarbon via solution of at least a portion of the reaction product with the unreacted aromatic monomer in a paraffinic solvent and bringing this solution into contact with a crystalline metallic aluminosilicate. There is no mention of use of zeolites of MFI structure type.

EP 1 149 863 A1 describes colorless and low-emission plastics which comprise at least one zeolite of MFI structure type. The parent material used can comprise conventional plastics, and polystyrene is also mentioned in a long list of possible plastics here. No polystyrene is used in the examples.

WO 01/34689 describes an aqueous polymer composition for production of floor coverings with low odor with an aqueous dispersed polymeric material and with a zeolite. Possible materials mentioned for the aqueous polymeric materials include styrene copolymers in a wide variety of possibilites. However, the examples use only polyurethane.

WO 01110966 describes a water-based adhesive composition with various components, inter alia with a polymer and with a filler. The polymer can be selected from a wide variety of polymers, inter alia styrene copolymers. However, all of the compositions described are aqueous, rather than molding compositions. There is no mention of use of zeolites of MFI structure type.

It was an object of the present invention to eliminate the abovementioned disadvantages.

A simple process has been developed here for obtaining styrene polymers whose styrene monomer content from the polymerization reaction has been reduced, and for providing the molding compositions obtained therewith.

Achievement of the object is obtained through a molding composition comprising at least one styrene polymer and comprising at least one zeolitic material of MFI structure type.

In one preferred embodiment, the inventive molding composition comprises a styrene polymer selected from the group consisting of homo- and copolymers of styrene, particularly preferably selected from the group consisting of styrene homopolymer, standard polystyrene (general-purpose polystyrene (GPPS)), high-impact polystyrene (HIPS), styrene-acrylonitrile copolymer (SAN), and acrylonitrile-butadiene-styrene (ABS), and in particular styrene homopolymer and SAN.

The term “styrene” used for the purposes of the present invention designates unsubstituted styrene and styrenes having from one to three C1-C4-alkyl or halogen substituents in the α-position and/or on the ring, preferably styrene, α-methylstyrene, or p-methylstyrene. Unsubstituted styrene is particularly preferred.

Styrene copolymers preferably comprise, in addition to styrene, as described above, ethylenically unsaturated monomers, particularly preferably selected from C₂-C₈ monoolefins, such as propylene, 1-butene, 1-hexene, and 1-octene, acrylates and methacrylates having from 1 to 8 carbon atoms in the alkyl radical, e.g. methyl methacrylate, butyl (meth)acrylate, and ethylhexyl (meth)acrylate, acrylonitrile, methacrylonitrile, and maleic acid derivatives, such as maleic anhydride and maleimide. Particularly preferred other ethylenically unsaturated monomers are (meth)acrylonitrile, C₁-C₈-alkyl (meth)acrylate, and maleic anhydride. Acrylonitrile is particularly preferred.

The inventive molding composition is particularly preferably composed of styrene polymers, where this means that no polymers are present in which styrene is not present. The inventive molding composition particularly preferably comprises just one styrene polymer.

In one preferred embodiment, the inventive molding composition comprises an amount of from about 95 to about 99.9% by weight, particularly preferably from about 97.5 to about 99.7% by weight, particularly preferably from about 98 to about 99.5% by weight, based on the total weight of the molding composition, of the styrene polymer.

The expression “zeolitic material of MFI structure type” used for the purposes of the present invention designates crystalline aluminosilicates having ordered channel-and-cage structures. The lattice of these zeolites is composed of SiO₄— and AlO₄— tetrahedra, bonded by way of shared oxygen bridges. A description of these structures is available by way of the Internet, at the URL http://topaz.ethz.ch/IZA-SC/searchRef.htm.

To compensate for the negative electrovalency produced via incorporation of Al(III) into the Si(IV)-silicate lattice, replaceable cations are found in zeolitic materials. These can in particular—as a function of the process used to produce the zeolitic material—be, for example, cations of sodium, of potassium, of lithium, of rubidium, or of cesium. Zeolitic material can also comprise ammonium ions as cations. If these cations are replaced by protons, for example via ion exchange, the result is the corresponding materials in the form known as the acidic form, the H form.

In one preferred embodiment, the inventive molding compositions therefore comprise the zeolitic material of MFI structure type in H form or in Na form.

The pore diameter of the zeolitic material is preferably in the range from 0.30 to 0.90 nm, particularly preferably in the range from 0.45 to 0.55 nm.

The particle size of the zeolitic material is preferably from 50 to 5000 nm, determined by scanning electron microscopy.

According to another preferred embodiment, the zeolitic material has at least 10-ring channels.

The inventive molding compositions comprise at least one zeolitic material, for example one, two, three, four, or more different zeolitic materials. The inventive molding compositions particularly preferably comprise a single zeolitic material.

In one preferred embodiment, the inventive molding composition comprises a zeolitic material of MFI structure type selected from the group consisting of crystalline aluminosilicates and titanium aluminosilicates.

Particular preference is given to an Si:Al ratio, calculated as molar SiO₂:Al₂O₃ ratio, in the range from 1000:1 to 10:1, preferably from 100:1 to 10:1, particularly preferably from 1 1:1 to 14:1, in particular (about) 12:1.

In one preferred embodiment, the inventive molding compositions comprise an amount of from about 0.1 to about 5% by weight, particularly preferably from about 0.3 to about 2.5% by weight, in particular from about 0.5 to about 2% by weight, particularly preferably about 2% by weight, based on the total weight of the molding composition, of the zeolitic material of MFI structure type. The reduction of styrene monomer content and zeolite content was determined gravimetrically or by means of GC.

Surprisingly, it has been found that use of zeolitic material of MFI structure type can markedly reduce styrene monomer content in the styrene polymer. In one particularly preferred embodiment, the inventive molding compositions therefore have styrene monomer content which has been reduced by at least about 5% by weight, particularly preferably about 10% by weight, in particular about 20% by weight, in comparison with the molding composition without the at least one zeolitic material.

In another embodiment, the present invention provides a process for removal of styrene monomer from a molding composition comprising at least one styrene polymer, comprising the steps of a) provision of a solid molding composition, comprising at least one styrene polymer, b) addition of a zeolitic material of MFI structure type, and c) heating the mixture resulting from step b).

The molding composition provided in step a) with the styrene polymer, and the zeolitic material of MFI structure type added in step b) are preferably as described above in relation to the inventive molding composition.

In one preferred embodiment, the molding composition is provided in step a) in the form of granules, powders, solutions, or melts.

It is preferable that in step b) the zeolitic material of MFI structure type is added prior to or in the extruder at temperatures of from 20 to 250° C. and homogeneously mixed with the molding composition. It is particularly preferable that the zeolitic material of MFI structure type is added to the solid molding composition at room temperature.

In step c), the composition resulting from step b) is heated, preferably to a temperature in the range from about 100 to about 300° C., in particular from about 150 to about 270° C. In one particularly preferred embodiment, in step c), the material is heated to melting point (from about 150 to 270° C., preferably from 180 to 220° C., particularly preferably from 190 to 210° C.) and simultaneously extruded in an extruder, such as a twin-screw extruder.

After heating in step c), the material obtained can be cooled. The material solidifies here. The solid material can then be granulated.

In another embodiment, the present invention provides the use of at least one zeolitic material of MFI structure type for removal of styrene monomer from a molding composition comprising at least one styrene polymer.

The molding composition with the styrene polymer and the zeolitic material of MFI structure type preferably comply with the above description of the inventive molding composition. The use preferably comprises the use in the inventive process.

### EXAMPLES

Zeolitic Material

B3: Zeocat Z6-01-01 from Zeochem AG, Uetikon, CH, FAU structure, sodium form, Si:Al ratio 2.7=3, 12-ring pores, pore diameter 0.74 nm

B4: Zeocat PZ 2/25Na from Zeochem AG, Uetikon, CH, MFI structure, sodium form, Si:Al ratio=12, 10-ring pores, pore diameter 0.55 nm

B5: Zeocat PZ 2/25H from Zeochem AG, Uetikon, CH, MFI structure, H form, Si:Al ratio=10-ring pores, pore diameter 0.55 nm

B6: TS1 (BASF laboratory specimen), MFI structure, titanium form, Si:Al ratio=10-ring pores, pore diameter 0.55 nm

### Examples 1 to 10

Standard Polystyrene (General-Purpose Polystyrene (GPPS))

x g of a zeolite were added to 1000 g of GPPS granules (VPT from BASF) and mixed manually in a plastics container. The resultant granules were finally extruded in a twin-screw machine (ZSK 30, combination 55J). The extruder was operated at 240° C. with rotation rate of 250 rpm and throughput of 10 kg/h. The styrene polymer obtained was pelletized.

The concentrations of styrene in the products obtained were measured by means of GC and are collated in Table 1 below.

TABLE 1

| | | | | | Residual |
|---|---|---|---|---|---|
| | GPPS | Zeocat | Zeocat | TS1 (Ti) | styrene |
| | [% by | P2/25H | 2/25Na | [% by | monomer |
| Example | wt.] | [% by wt.] | [% by wt.] | wt.] | [ppm] |
| 1 | 100 | — | — | — | 475 |
| (comparative)) | | | | | |
| 2 | 99.5 | 0.5 | — | — | 347 |
| 3 | 99.0 | 1.0 | — | — | 0 |
| 4 | 98.0 | 2.0 | — | — | 0 |
| 5 | 99.5 | — | 0.5 | — | 460 |
| 6 | 99.0 | — | 1.0 | — | 416 |
| 7 | 98.0 | — | 2.0 | — | 329 |
| 8 | 99.5 | — | — | 0.5 | 437 |
| 9 | 99.0 | — | — | 1.0 | 370 |
| 10 | 98.0 | — | — | 2.0 | 276 |

Examples 2 to 4, 7, and 10 became pink to violet

### Example 1 (Comparative Example)

### Straight GPPS was Passed to the Extruder Without Zeolite

### Examples 11 to 20

High-Impact Polystyrene (HIPS)

Examples 11 to 20 were repeated with the difference that HIPS (PS 486M from BASF) was used.

The concentrations of styrene in the products obtained were measured by means of GC and are collated in Table 2 below

TABLE 2

| | | Zeocat | | | Residual |
|---|---|---|---|---|---|
| | | P2/25H | Zeocat | | styrene |
| | HIPS | [% by | 2/25Na | TS1 (Ti) | monomer |
| Example | [% by wt.] | wt.] | [% by wt.] | [% by wt.] | [ppm] |
| 11 | 100 | — | — | — | 513 |
| (comparative) | | | | | |
| 12 | 99.5 | 0.5 | — | — | 399 |
| 13 | 99.0 | 1.0 | — | — | 78 |
| 14 | 98.0 | 2.0 | — | — | 22 |
| 15 | 99.5 | — | 0.5 | — | 484 |
| 16 | 99.0 | — | 1.0 | — | 501 |
| 17 | 98.0 | — | 2.0 | — | 480 |
| 18 | 99.5 | — | — | 0.5 | |
| 19 | 99.0 | — | — | 1.0 | 447 |
| 20 | 98.0 | — | — | 2.0 | 335 |

Examples 12 to 14 and 20 became pink to violet

### Example 11 (Comparative Example)

### Straight HIPS was Passed to the Extruder Without Zeolite

### Examples 21 to 29

Styrene-Acrylonitrile Copolymer (SAN)

x g of a zeolite were added to 1000 g of SAN granules (VLN from BASF) and mixed manually in a plastics container. The resultant granules were finally extruded in a twin-screw machine (ZSK 30, combination 55J). The extruder was operated at 240° C. with rotation rate of 250 rpm and throughput of 10 kg/h. The styrene polymer obtained was pelletized.

The concentrations of styrene in the products obtained were measured by means of GC and are collated in Table 3 below.

TABLE 3

| | | Zeocat | Zeocat | |
|---|---|---|---|---|
| | HIPS | P2/25H | Z6-01-01 | Residual styrene |
| Example | [% by wt.] | [% by wt.] | [% by wt.] | monomer [ppm] |
| 21 | 100 | — | — | 600 |
| (comparative) | | | | |
| 22 | 99.9 | 0.1 | — | 600 |
| 23 | 99.5 | 0.5 | — | 400 |
| 24 | 99.0 | 1.0 | — | 160 |
| 25 | 98.0 | 2.0 | — | 10 |
| 26 | 99.9 | — | 0.1 | 600 |
| 27 | 99.5 | — | 0.5 | 530 |
| 28 | 99.0 | — | 1.0 | 450 |
| 29 | 98.0 | — | 2.0 | 330 |

Examples 22 to 25 became pink to violet

### Comparative Example 21 (Comp)

Straight SAN was Passed to the Extruder Without Zeolite

1.-17. (canceled)

18. A molding composition, comprising at least one styrene polymer and comprising at least one zeolitic material of MFI structure type.

19. The molding composition according to claim 18, wherein the styrene polymer is a homopolymer or copolymer of styrene.

20. The molding composition according to claim 19, wherein the styrene polymer is selected from the group consisting of styrene homopolymer, standard polystyrene (general-purpose polystyrene (GPPS)), high-impact polystyrene (HIPS), styrene-acrylonitrile copolymer (SAN) and acrylonitrile-butadiene-styrene (ABS).

21. The molding composition as claimed in claim 18, wherein the amount present of the styrene polymer is from about 95 to about 99.9% by weight, based on the total weight of the molding composition.

22. The molding composition according to claim 18, wherein the zeolitic material of MFI structure type is a crystalline aluminosilicate or a titanium aluminosilicate.

23. The molding composition according to claim 18, wherein the zeolitic material of MFI structure type is present in H form or in Na form.

24. The molding composition according to claim 18, wherein the amount present of the zeolitic material is from about 0.1 to about 5% by weight, based on the total weight of the molding composition.

25. The molding composition according to claim 18, wherein the molding composition comprises styrene monomer content which has been reduced by at least about 5% by weight in comparison with the molding composition without the at least one zeolitic material.

26. The molding composition according to claim 20, wherein the zeolitic material of MFI structure type is a crystalline aluminosilicate or a titanium aluminosilicate and the amount present of the styrene polymer is from about 95 to about 99.9% by weight, based on the total weight of the molding composition and the amount present of the zeolitic material is from about 0.1 to about 5% by weight, based on the total weight of the molding composition.

27. A process for removal of styrene monomer from a molding composition, comprising at least one styrene polymer, comprising the steps of
a) providing a solid molding composition, comprising at least one styrene polymer,
b) adding a zeolitic material of MFI structure type, and
c) heating the mixture resulting from step b).

28. The process according to claim 27, wherein the styrene polymer provided in step a) is a homopolymer or a copolymer of styrene.

29. The process according to claim 27, wherein the styrene polymer is selected from the group consisting of styrene homopolymer, standard polystyrene (general-purpose polystyrene (GPPS)), high-impact polystyrene (HIPS), styrene-acrylonitrile copolymer (SAN) and acrylonitrile-butadiene-styrene (ABS).

30. The process according to claim 27, wherein the amount added in step a) of the styrene polymer is from about 95 to about 99.9% by weight, based on the total weight of the molding composition.

31. The process according to claim 27, wherein the zeolitic material of MFI structure type added in step b) is a crystalline aluminosilicate or a titanium aluminosilicate.

32. The process according to claim 27, wherein the zeolitic material of MFI structure type added in step b) is present in H form or in Na form.

33. The process according to claim 27, wherein the amount added of the zeolitic material in step b) is from 0.1 to 5% by weight, based on the total weight of the molding composition.

34. The process according to claim 27, wherein the mixture resulting from step c) comprises styrene monomer content which has been reduced by at least about 5% by weight in comparison with the molding composition provided in step a).

35. The process according to claim 27, wherein the zeolitic material of MFI structure type is a crystalline aluminosilicate or a titanium aluminosilicate and the amount present of the styrene polymer is from about 95 to about 99.9% by weight, based on the total weight of the molding composition and the amount present of the zeolitic material is from about 0.1 to about 5% by weight, based on the total weight of the molding composition.
